(19) United States
(12) Patent Application Publication
(10) Pub. No.: US 2010/0121473 A1
(43) Pub. Date: May 13, 2010

(54) System and method for optimizing lignocellulosic granular matter refining

(75) Inventors: Feng Ding, Québec (CA); Llich Lama, Quebec (CA); Richard Gagnon, Quebec (CA); Claude Lejeune, Quebec (CA)

Correspondence Address: JEAN-CLAUDE BOUDREAU, CRIQ BUILDING, 8475, CHRISTOPHE-COLOMB, MONTREAL, QC, H2M 2N9, CA

(73) Assignee: Centre de recherche industrielle du Québec, Québec, QC (CA)

(21) Appl. No.: 12/598,644

(22) PCT Filed: May 2, 2008
(86) PCT No.: PCT/CA08/00857

§ 371 Date: Nov. 3, 2009

(30) Foreign Application Priority Data
May 4, 2007 (CA) 2588050
Feb. 5, 2008 (CA) 2619904

(51) Int. Cl. G05B 13/04; G06G 7/66; G06N 3/02; G06N 7/02; G06F 1/26

(52) U.S. Cl. 700/104; 703/7; 706/23; 706/52; 700/291

(57) ABSTRACT

A system and method for optimizing a process for refining lignocellulosic granular matter such as wood chips use a predictive model including a simulation model based on relations involving a plurality of matter properties characterizing the matter such as moisture content, density, light reflection or granular matter size, refining process operating parameters such as transfer screw speed, dilution flow, hydraulic pressure, plate gaps, or retention delays, at least one output controlled to a target such as primary motor load or pulp freeness, and at least one uncontrolled output such as specific energy consumption, energy split, long fibers, fines and shives. An adaptor is fed with measured values of matter properties and measured values of controlled and uncontrolled outputs, to adapt the simulation model accordingly. An optimizer generates a value of the target according to a predetermined condition on a predicted uncontrolled output parameter and to one or more process constraints.

### FIELD OF THE INVENTION

The present invention relates to the field of lignocellulosic granular matter refining processes such as used for pulp and paper production and for wood fibreboard manufacturing.

### BACKGROUND OF THE INVENTION

In the Thermomechanical Pulping Process (TMP), wood chips are used as lignocellulosic raw matter, and their properties such as species, freshness, size, density and moisture content are important factors affecting pulp quality, as stated by Smook in “Handbook for Pulp & Paper Technologies”, Joint Textbook Committee of the Paper Industry, 54 (1982), and can have an impact on energy consumption and process stability as discussed by Garceau in “Pâtes Mécaniques et Chimico-Mécaniques. La section technique”, PAPTAC, (1989) Montreal, Canada, pp. 101 (1989). The relations between the refining process and pulp quality have been exhaustively discussed by Miles in “Refining Intensity and Pulp Quality in High-Consistency Refining”, Paperi ja Puu—Paper and Timber, 72(5): 508-514, (1990), by Stationwala et al. in “Effect of Feed Rate on Refining”, Journal of Pulp and Paper Science: vol 20 no 8 (1994) and by Wood . in “Chip Quality Effects in Mechanical Pulping—A Selected Review” 1996 Pulping Conference pp. 491-495. Furthermore, the relations between refining process and chip properties have also been exhaustively discussed by Jensen et al. in “Effect of Chip Quality on Pulp Quality and Energy Consumption in RMP Manufacture”, Int symp. on fundamental concepts of refining, Appleton Wis., sept. (1980), by Breck et al. in “Thermomechanical Pulping—a Preliminary Optimization”, Transactions, Section technique, ACPPP, 1-3, pp 89-95 (1975) and by Eriksen et al. in “Consequences of Chip quality for Process and Pulp Quality in TMP Production”, International Conference, Mechanical Pulping, Oslo, June (1981).

According to a known control strategy, a feedback controller is used on the chip transfer screw feeder to control primary motor load, the dilution flow rate for the primary refiner being coupled with the screw feeding to operate on a constant ratio mode. Alternatively, the feedback controller can be used to control the motor load by acting upon the dilution flow rate on the basis of a pulp consistency measurement at the blow line of the primary refiner. In both cases, the variation of chip quality acts as an external disturbance affecting the motor load.

The TMP mills are large consumers of electrical energy. Disc refiners, typically powered by large 10-30 MW electric motors, are used to convert wood chips to high quality papermaking fibers. According to analysis results of M. Jackson et al. reported in “ Mechanical Pulp Mill “, Energy Cost Reduction in the Pulp and Paper Industry, Browne, T. C. tech. ed. , Paprican (1999) , the energy consumption for a 500 BDMT/D (Bone Dry Metric Ton per Day) single-line TMP mill at 2400 kWh/BDMT, which is typical for a TMP mill using black spruce chips for newsprint production, was estimated at 2160 KWh/ADt (KWatt-hour per Air Dry ton) which corresponds to 90% of the whole mill energy consumption. Since the TMP process is used in 80% of the newsprint production worldwide, energy consumption is a major issue in that industry.

Presently, variations in specific energy consumption (SEC), i.e. applied energy per unit of weight of wood chips on an oven-dry basis during refining, to obtain a desired pulp quality can be relatively high. Usually there is a range of desired quality values, such as provided by Canadian Standard Freeness (CSF) for example, with which the produced pulp must comply to satisfy customers' demand. In this range, the obtained CSF can sometimes be near the upper limit or the lower limit. When the value is near the lower limit of the desired range, this means that more energy is needed to reach the desired quality. When the value is near the upper limit, a minimal consumption of energy for an acceptable quality pulp is reached. For cost reduction and resource protection purposes, it is desirable that energy spent to produce a pulp of a desired quality is managed efficiently.

Refiners are also involved in the manufacturing of fibreboards made from various lignocellulosic granular matters including wood chips and mill waste matters such as wood shavings, sawdust or processed wood flakes (e.g. OSB flakes). While the respective post-refining steps of fiberboard manufacturing and pulp and paper processes are distinct, their refining modes of operation are similar, and cost reduction as well as resource protection are important issues for both processes, so that it is still desirable that energy spent to produce a pulp of a desired quality is managed efficiently.

### SUMMARY OF THE INVENTION

According to a first broad aspect of the invention, there is provided a method for optimizing the operation of a lignocellulosic granular matter refining process using a control unit and at least one refiner stage, said process being characterized by a plurality of input operating parameters, at least one output parameter being controlled by said unit with reference to a corresponding control target, and at least one uncontrolled output parameter. The method comprises the steps of: i) providing a predictive model including a simulation model for the refining process and an adaptor for the simulation model, the simulation model being based on relations involving a plurality of matter properties characterizing lignocellulosic matter to be fed to the process, the refining process input operating parameters, the controlled output parameter and the uncontrolled output parameter, to generate a predicted value of the uncontrolled output parameter; ii) feeding the simulation model adaptor with data representing measured values of the matter properties and data representing measured values of said controlled and uncontrolled output parameters, to adapt the relations of said simulation model accordingly; and iii) providing an optimizer for generating an optimal value of the control target according to a predetermined condition on the predicted value of the uncontrolled output parameter and to one or more predetermined process constraints related to one or more of the matter properties, the refining process input operating parameters and the refining process output parameter.

According to a second broad aspect of the invention, there is provided a system for optimizing the operation of a lignocellulosic refining process using a control unit and at least one refiner stage, said process being characterized by a plurality of input operating parameters, at least one output parameter being controlled by said unit with reference to a corresponding control target, and at least one uncontrolled output parameter. The system comprises means for measuring a plurality of matter properties characterizing lignocellulosic matter to be fed to the process, to generate matter property data, means for measuring said controlled and uncontrolled output parameters, to generate output parameter data, and data processor means implementing a predictive model including a simulation model for said matter refining process which is based on relations involving said plurality of matter properties, said refining process input operating parameters, said controlled output parameter and said uncontrolled output parameter, to generate a predicted value of said uncontrolled output parameter, said data processor means further implementing an adaptor for said simulation model receiving said matter property data and said output parameter data to adapt the relations of said simulation model accordingly, said data processor means further implementing an optimizer for generating an optimal value of said control target according to a predetermined condition on said predicted value of said uncontrolled output parameter and to one or more predetermined process constraints related to one or more of said matter properties, said refining process input operating parameters and said refining process output parameter.

### BRIEF DESCRIPTION OF THE DRAWINGS

Preferred embodiment of the proposed system and method for optimizing wood chips refining will be described below in view of the accompanying drawings in which:

FIG. 1 is a graph showing an example of variability exhibited by CSF and SEC with time as observed using a conventional refiner control strategy;

FIG. 2 is a graph showing an example of controllable area delimited by constraints in the context of a refining process involving two degrees of freedom;

FIG. 3 is a schematic block diagram of the online chip quality measurement system that can be used to provide chip property data;

FIG. 4 is a typical volume representation provided by a volume sensor included in the system of FIG. 3;

FIG. 5 is a perspective view of a granular matter size measuring subsystem provided on the system of FIG. 3;

FIG. 6 is an example of raw 3D image obtained with the granular matter size measuring subsystem of FIG. 5;

FIG. 7 is a conventional 3D representation of an image such as shown in FIG. 6;

FIG. 8 represents a view of a wood chip sample spread on the surface of a conveyer for estimating the actual distributions of areas;

FIG. 9 is a graph presenting the curves of actual distributions of the areas of spread wood chips obtained from the batches sifted to 9.5 mm (⅜ in) and 22 mm (⅞ in);

FIG. 10 is a graph presenting the curve of actual distribution of the areas of spread wood chips obtained from the batch sifted to 22 mm (⅞ in) of FIG. 5, and the curve of distribution estimated from a segmentation of 3D images of the same wood chips as inspected in bulk;

FIG. 11 is a graph presenting the curve of actual distribution of the areas of spread wood chips obtained from the batch sifted to 9.5 mm (⅜ in) of FIG. 5, and the curve of distribution estimated from a segmentation of 3D images of the same chips as inspected in bulk;

FIG. 12 is a graph presenting the curve of actual distribution of the areas of spread wood chips obtained from a mix of chips from the batches sifted to 9.5 mm (⅜ in) and 22 mm (⅞ in), and the curves of distributions of areas of the same chips as inspected in bulk following the segmentation of a set of images;

FIG. 13 is an example of 3D image processed with the application of a gradient during the segmentation step;

FIG. 14 is a portion of an inverted binary image obtained with thresholding from the image of FIG. 13;

FIG. 15 is a portion of an image obtained with morphological operations of dilatation and erosion from the image portion of FIG. 14;

FIG. 16 is a portion of an image obtained through a pre-selection according to a perimeter/area ratio for regions within the image portion of FIG. 15 to retain for generating statistical data;

FIG. 17 is a portion of an image produced by filtering of the image portion of FIG. 16 for locating obstruction zones;

FIG. 18 is a final image resulting from the segmentation step, superimposed to the raw image of FIG. 6;

FIG. 19 is a process flow diagram of a typical TMP pulp mill implementing a 2-stage TMP process;

FIG. 20 is a chip pile dosage stage used to stabilize chip quality prior to refining;

FIG. 21a is a schematic block diagram of basic SEC optimization structure for use with a simulation model of a refining process;

FIG. 21b is a schematic block diagram showing the basic optimized simulation model used to operate an actual refining process in open-loop control configuration;

FIG. 21c is a schematic block diagram showing the basic simulation model used in a predictive way to estimate quality-related pulp properties;

FIG. 22 is a schematic block diagram representing a chip refining optimization and control system capable of minimizing SEC.

### DETAILED DESCRIPTION OF EMBODIMENTS

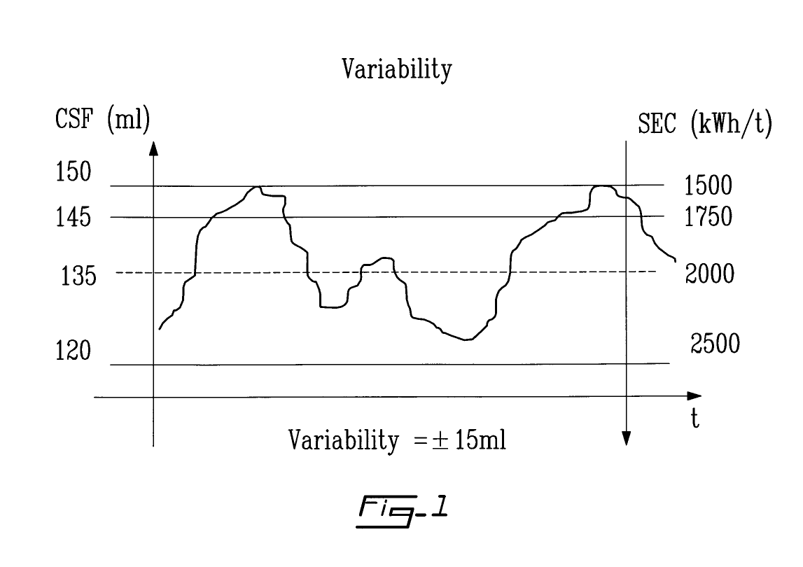

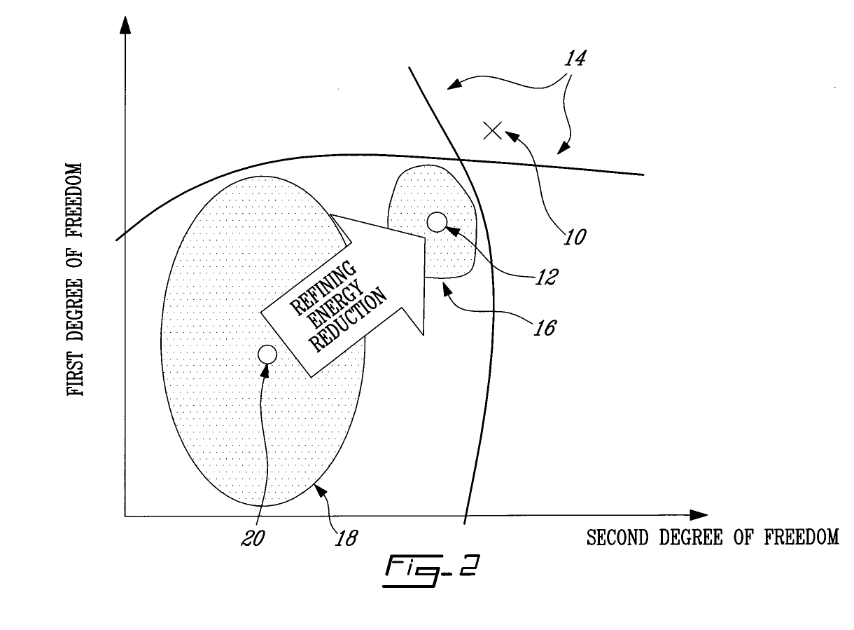

Variations in properties of lignocellulosic raw matter can lead to large deviations in both quality of pulp produced therefrom as well as energy used to obtain it. In the TMP process, variations in wood chip properties lead to change in the mass flow rate of the chips fed into the refiner. Experiences have shown that for a normal operating condition, 30% of disturbances affecting the pulping process may be caused by these variations. Referring to the example shown in the graph of FIG. 1, CSF exhibits a variability of ±15 mL with reference to CSFₘₑₐₙ=135 mL, while SEC exhibits a variability of ±1500 kWh/t with reference to SECₘₑₐₙ=2000 kWh/t. If the SEC variation could be minimized, it would be possible to produce a pulp of higher quality, e.g. CSFₘₑₐₙ=145 mL or approaching its upper limit (150 mL) for a same refining energy consumption, or to produce a pulp with same CSFₘₑₐₙ value (135 mL) while consuming less energy. Usually, at the refiner stages, energy consumption does not only depend on chip quality and refining process control strategy. Energy consumption also depends on mill's design and its inherent process constraints. Under given operating conditions, there is usually a compromise to make between optimality in terms of controlled parameter variability reduction and process controllability. Minimizing the variability of a controlled parameter gives rise to a possibility of moving the operating point so as to reach a more optimal operation. Referring to the example of controllable area in the context of a refining process involving two degrees of freedom (controllable parameters) shown in the graph of FIG. 2, when the optimal operating point indicated at numeral 10 is out of the controllable area, a selected operating point as indicated at 12 must approach one or more process constraints represented by limit curves 14 as much as possible within the controllable area. That principle generally entails a reduction of controllability since the final margin for manoeuvring to stabilize the system upon external disturbance as represented by area 16 decreases accordingly as compared to the current margin for manoeuvring represented by area 18 around current operation point 20. Hence, if a mill has means to measure and control wood chip quality variability, the required margin for control is reduced, and the operating conditions can safely move closer the process constraints with more security, thus becoming more optimal. As a result, this may lead to a reduction of refining energy consumption.

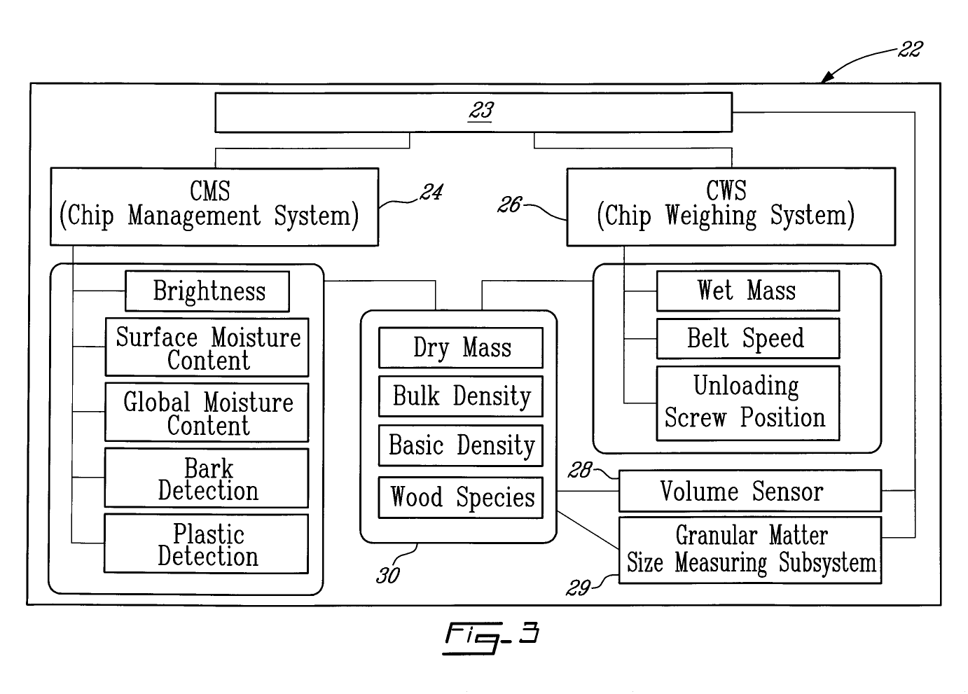

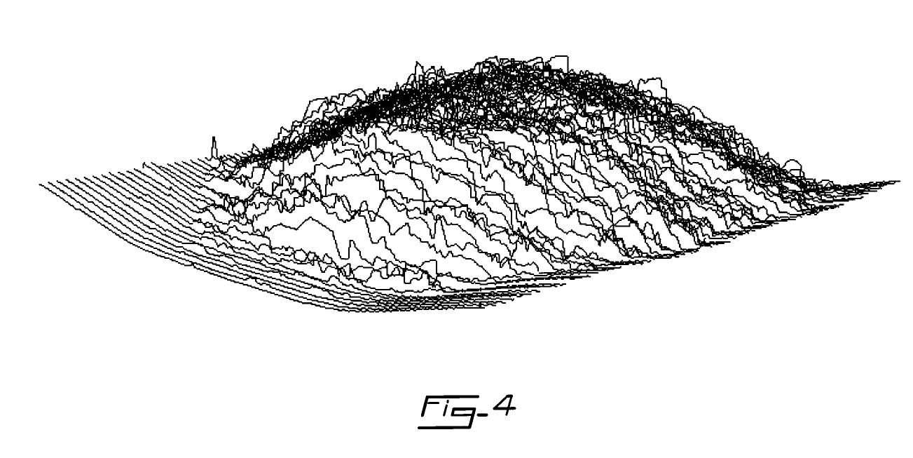

Heretofore, the variation of chip quality acting as an external disturbance has not been considered when designing refiner control strategies. The proposed approach considers the relations between chip properties and pulp quality. For doing so, chip properties can be measured online using existing chip measurement systems, such the Chip Management System (CMS) as described in U.S. Pat. No. 6,175,092 B1 and in U.S Pat. No. 7,292,949 B2, along with the Chip Weighing System (CWS) described in copending U.S. Patent application published under No. 2006/0278353 naming the present assignee, the entire content of all said Patent documents being incorporated herein by reference, all said systems being available from the present assignee. Referring to the schematic block diagram of FIG. 3 representing a chip quality online measurement system generally designated at 22 which includes a computer unit 23, the various chip characterizing properties measured by CMS at 24 includes brightness, surface moisture content, global moisture content, bark detection and plastic detection, while CWS at 26 provides wet mass, belt speed and unloading screw position data. Output parameters of CMS 24, CWS 26, and of a chip volume sensor at 28 such as described in the above cited U.S. application published under No. 2006/0278353, can be combined to derive dry mass, bulk density, basic density and wood species information as indicated in block 30. A typical volume representation provided by such volume sensor is shown in FIG. 4. Known applications of such measurement systems are further discussed in published U.S. Patent application published under no. 200410151361A1 and in the following papers: Ding et al. “Economizing the Bleaching Agent Consumption by Controlling Wood Chip Brightness”, Control System 2002, Proceedings, June 3-5, Stockholm, Sweden, 2002, pp. 205-209; Ding et al. “Effects of some Wood Chip Properties on Pulp Qualities”, 89th Annual Meeting PAPTAC. Montreal, 2003, pp. 37; Bédard et al. “Amélioration de la gestion de la cour à bois par la caractèrisation en ligne des copeaux”, Congrès Francophone du Papier, Château Frontenac, Quéec, Canada, 14-16 mai, 2003, pp. 11-15; Ding et al. “Wood Chip Physical Quality Definition and Measurement”, Pulp & Paper Canada, 2 (2005) 106, 27-32; Ding et al. “Online wood chip quality measurement: Chip density and wood species variation”, IMPC 2005, June 7-9, Oslo, Norway, 2005, pp. 298-301; and Ding et al. “Improvement and Prediction of Kraft Pulp Yield Using a Wood Chip Quality Online Measurement System (CMSE)”, Control Systems 2006, Proceedings, Jun. 6-8, 2006, Tampere, Finland, pp 123-128.

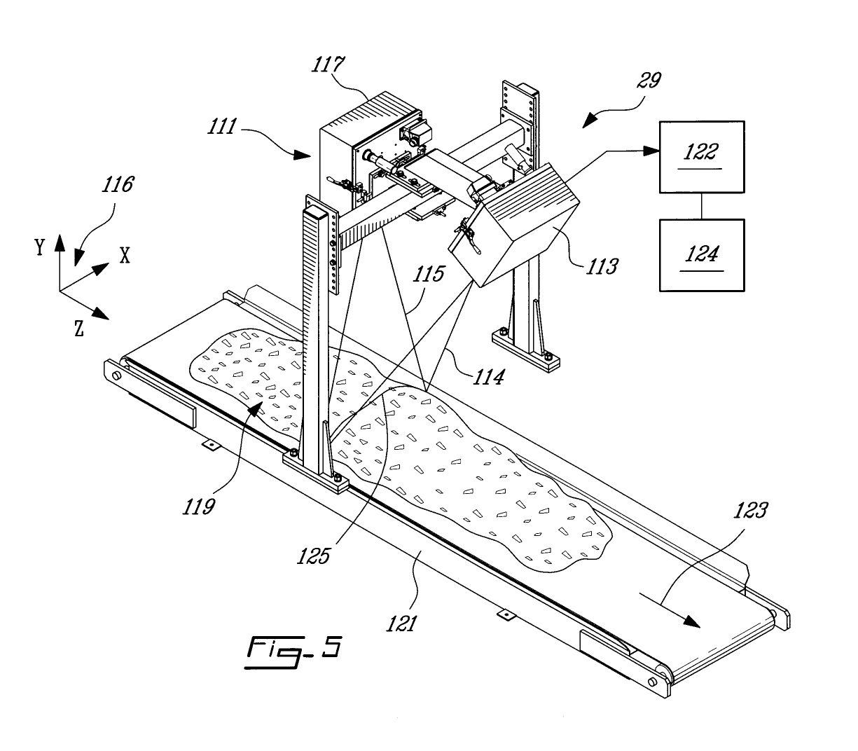

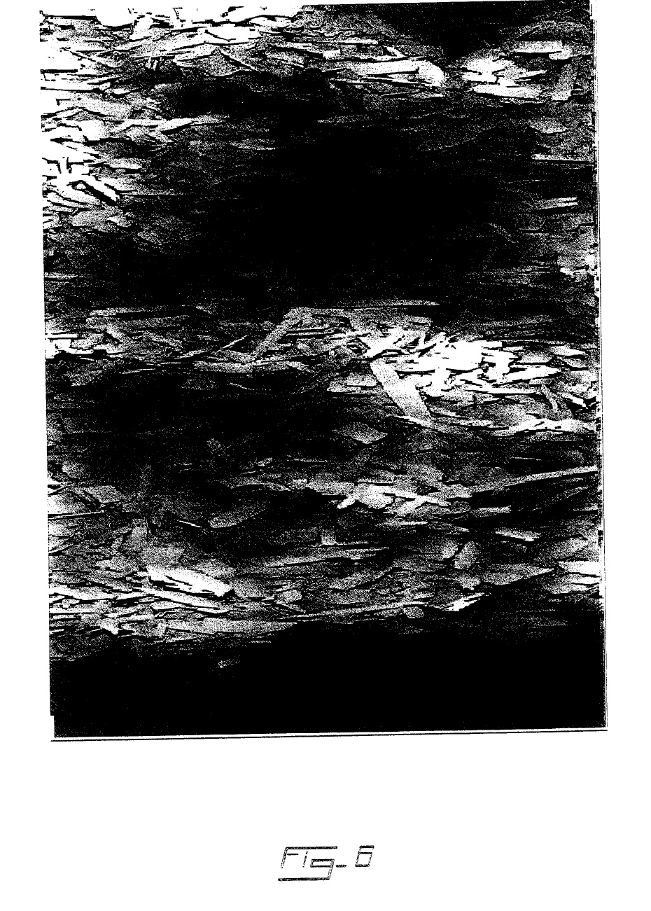

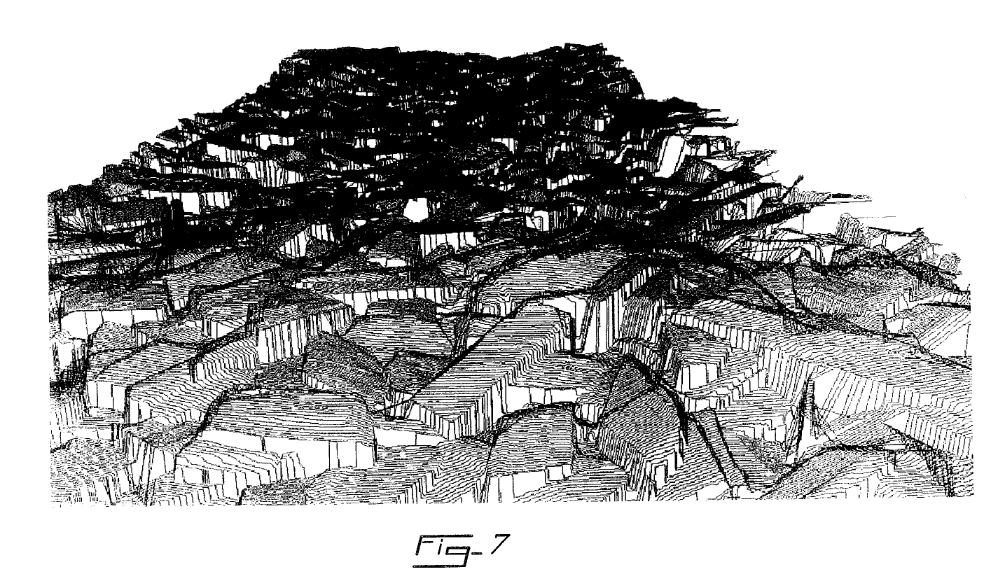

Optionally, a granular matter size measuring subsystem as represented at 29 in FIG. 3, which uses a laser ranging device, can be provided to generate chip size information. The granular matter size measuring subsystem 29 will now described in more detail in view of FIGS. 5 to 18. It is to be understood that any other appropriate chip sizing apparatus available in the marketplace may be alternatively used, such as the WipChip™ supplied by B & D Manufacturing (Chelmsford, Ontario, Canada), or the Scanchip™ from Iggesund Tools Inc. (Oldsmar, Fla.), with appropriate adaptation. The proposed granular matter size measuring subsystem 29 and associated measuring method use a three-dimensional (3D) imaging principle. Referring to FIG. 5, the subsystem 29 according to the shown embodiment includes a profile measuring unit 111 using a matrix camera 113 for capturing an image of a linear beam 115 projected by a laser source 17 onto the granular matter 119 moving under the field of vision 114 of camera 113, the matter 119 being transported on a conveyer 121 in the direction of arrow 123 in the example shown, which field of vision 114 forming a predetermined angle with respect to the plane defined by the laser beam 115. A linear array of pin-point laser sources could replace the linear laser source, and laser scanning of the surface of a still mass of granular matter could also be used. Since all points of the laser line 125 formed on the surface of matter 119 lay in a same plane, the height of each point of line 125 is derived through triangulation computing of by the use of a pre-calculated look-up table, so to obtain the X and Y coordinates of the points on the surface of the inspected matter, in view of the 3D reference system designated at 116. The triangulation may be calibrated with any appropriate method, such as the one described in Canadian published patent application No. CA 2,508,595. Alternatively, such as described in Canadian patent no. CA 2,237,640, a camera with a field of vision being perpendicular to the X-Y plane could be used along with a laser source disposed at angle, upon adaptation of the triangulation method accordingly. The triangulation program can be integrated in the built-in data processor of camera 113 or integrated in the data processor of computer 122 provided on the subsystem 29, which computer 122 performs acquisition of raw image data and processing thereof in a manner described below, the images being displayed on monitor 124. The third dimension in Z is given by successive images generated by camera 113 due to relative movement of matter 119. Hence, a 3D image exempt from information related to the coloration of inspected granular matter is obtained, such as the raw image shown in FIG. 6, wherein the grey levels of the points in the image do not represent the hue of the imaged surface, but rather provide a height indication (clearer is the hue, higher is the point). FIG. 7 shows a conventional 3D representation of a raw image such as shown in FIG. 6.

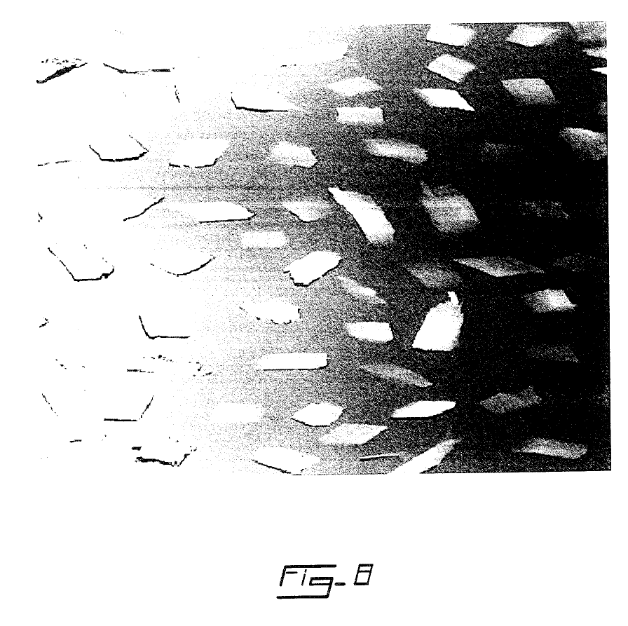

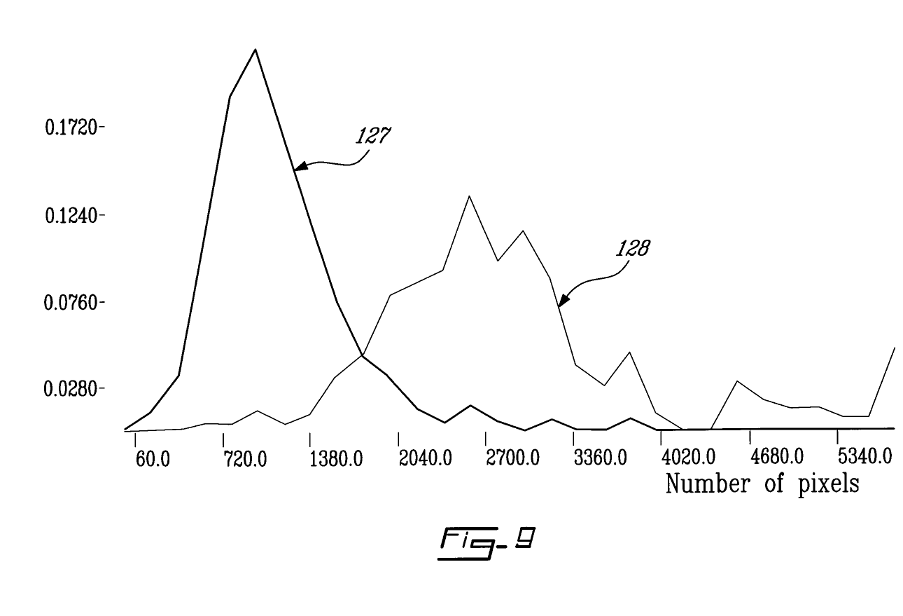

According to the proposed approach, there is a one-to-one relation between the distribution of dimensions as measured on bulk matter through 3D image segmentation processing, and the actual distribution determined from the analysis of individual granules. That relation was confirmed experimentally from a sample of wood chips (hundreds of litres) that was sifted to produce five (5) batches of chips presenting distinct dimensional characteristics such as expressed by statistical area distributions. The actual distributions of chip areas were measured by spreading the chips on the conveyer in such a manner that they can be isolated as shown in FIG. 8. Ten (10) images for each chip batch enabled obtaining reliable statistical data associated with a sample of about two thousands (2000) chips. Since sifting separates chips according to a single dimension, a Gaussian (normal) area distribution was observed for each sifted batch, such as exhibited by curves 127 and 128 on the graph of FIG. 9, for the batches sifted to 9.5 mm (⅜ in) and 22 mm (⅞ in), respectively.

A good segmentation algorithm must exhibit an optimal trade-off between the capability of detecting with certainty a wholly visible chip without overlap, and the capability of isolating a maximum number of chips in a same image so that the required statistical data could be acquired in a sufficiently short period of time. Many 3D image segmentation methods have been the subject of technical publications, such as those described by Pulli et al in <<Range Image Segmentation for 3-D Object Recognition>> University of Pennsylvania—Department of Computer and Information Science, Technical Report No. MS-CIS-88-32, May 1988, and by Gachter in <<Results on Range Image Segmentation for Service Robots>> Technical Report, Ecole Polytechnique Fédérale de Lausanne—Laboratoire de Système Autonomes, Version 2.1.1, September 2005.

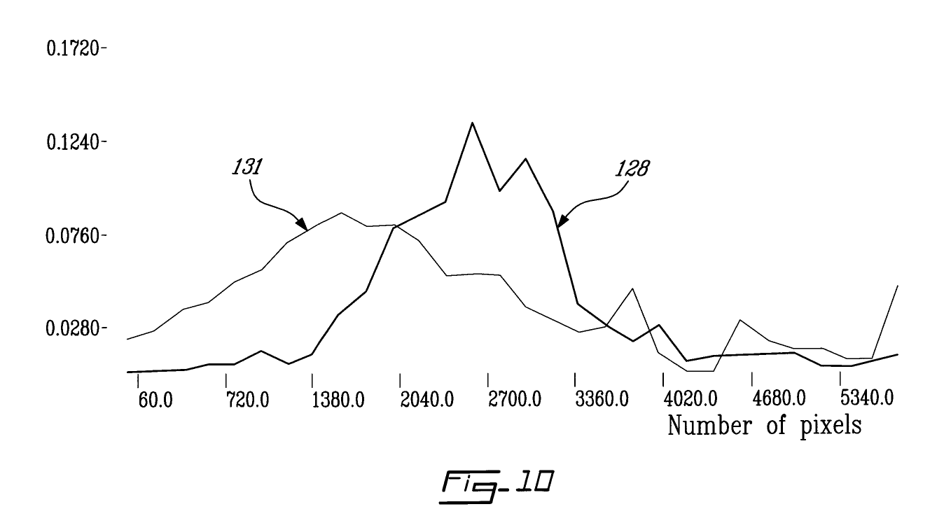

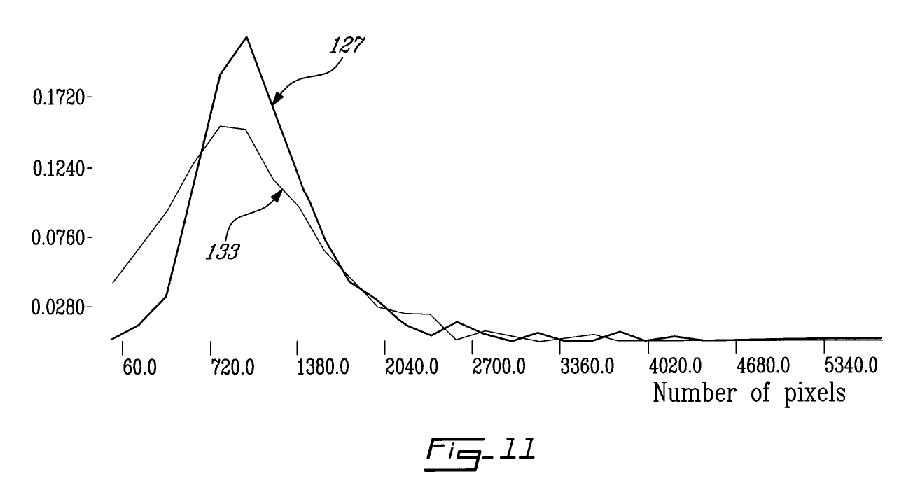

The graph of FIG. 10 presents a curve 128 of actual distributions for spread chips and curve 131 of distributions estimated from 3D image segmentation for chips from the batch sifted to 22 mm (⅞ in), using a basic segmentation method carried on by a program coded in C++ and executed by computer 22. The graph of FIG. 11 presents curve 127 of actual distributions for spread chips and curve 133 of distributions estimated from 3D image segmentation for chips from the batch sifted to 9.5 mm (⅜ in). It ca be observed from these graphs that estimations obtained with segmentation also provide a Gaussian distribution, but with a mean shifted toward the lowest values and with a higher spread (variance). Such bias can be explained by the fact that granules in bulk are found in random orientations thus generally reducing the estimated area for each granule on the one hand, and by the fact that the segmentation algorithm used would have a tendency to over-segmentation, on the other hand, thus favouring the low values. Notwithstanding that bias, at least for a Gaussian distribution, it is clear that a one-to-one relation exists between the distributions measured on chips in bulk and those of spread chips.

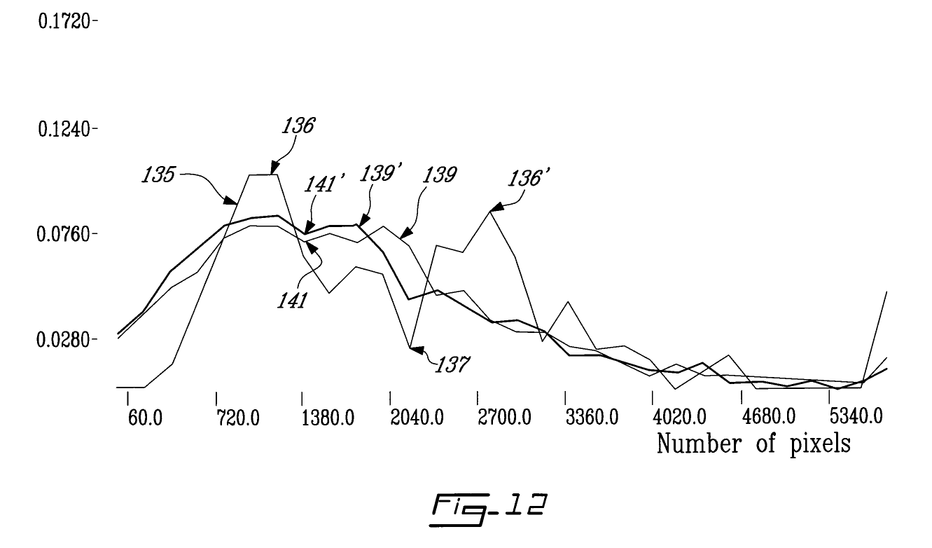

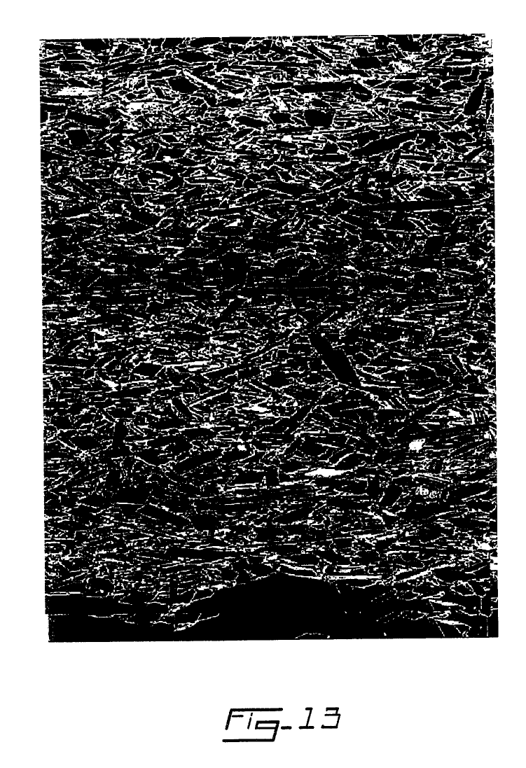

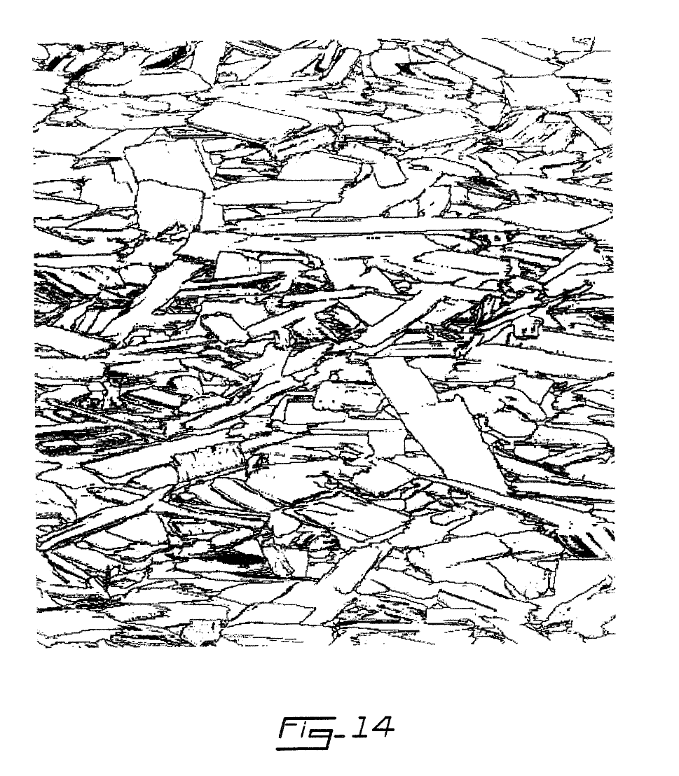

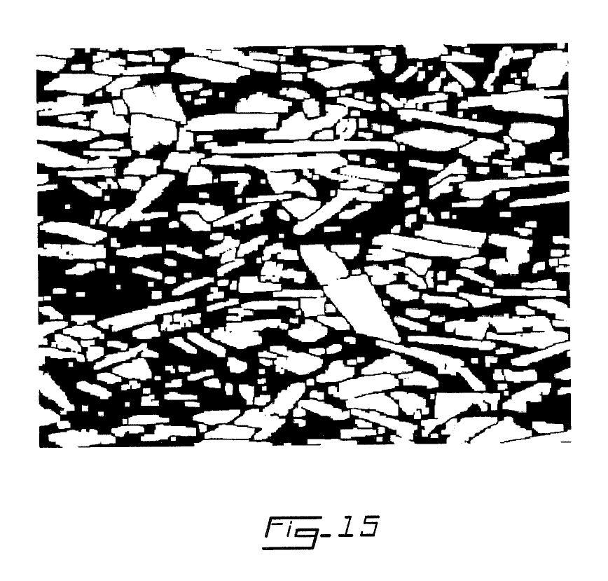

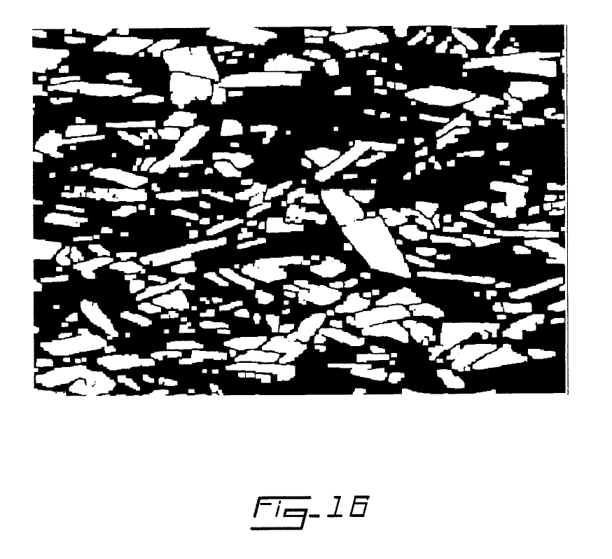

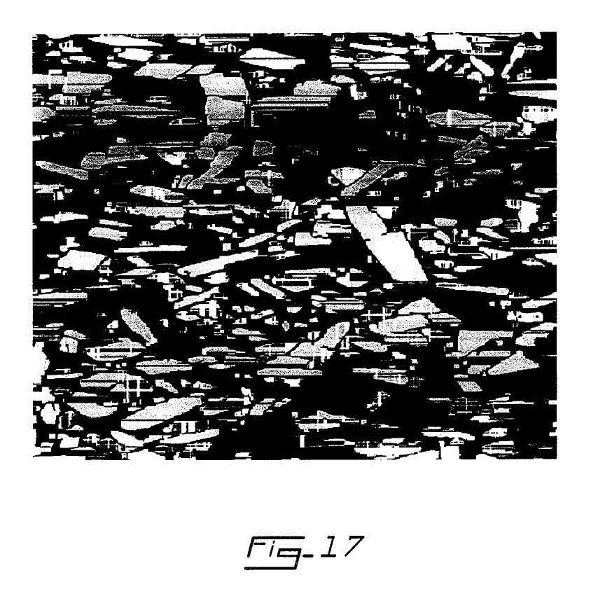

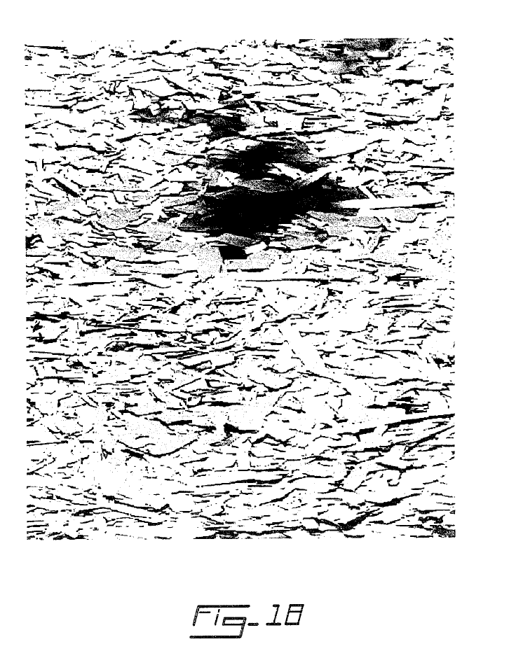

A chip sample characterized by a non-Gaussian distribution was produced by mixing chips form batches sifted to 9.5 mm (⅜ in) and 22 mm (⅞ in). The graph of FIG. 12 shows a curve 135 of distribution of areas obtained with spread chips. That distribution exhibits two (2) peaks 136 and 136′ separated by a local minimum 137 associated with absence of chips from the 16 mm (⅝ in) group. Curves 139 and 139′ of the same graph show the estimated distributions of areas following segmentation of sets of ten (10) and twenty (20) images of chips in bulk, respectively. Here again, one can observe a shift of means and a spread of peaks causing an overlap of the Gaussian distributions associated with the two batches of chips. Nevertheless, the presence of inflection points 141, 141′ located near the apex of the distributions of curves 139, 139′ indicates that two batches are involved, whose individual means can be estimated.

The experiences that were performed have demonstrated the reliability of estimation of area distribution for chips in bulk using 3D image analysis of chip surface. The estimations were found sufficiently accurate to produce chip size data usable for the control of pulp production process. That conclusion is valid provided that the chips located on top of an inspected pile of chips are substantially representative thereof as a whole, and that the segmentation induced bias is as constant as possible. In cases where some segregation of granules occurs on the transport line, a device forcing homogenization can be used upstream the measuring subsystem 10. Moreover, to the extent the granules are produced through identical or equivalent processes, one can assume that the granule characteristics influencing the segmentation bias are substantially constant. Nevertheless, in the case of wood chips, since it is possible that their forms vary somewhat with species, temperature at the production site or cutting tool wear, these factors may limit the final estimation accuracy. The spread of Gaussian distributions and the bias toward low values of mean area measurements can be reduced through geometric corrections applied on area calculations, which corrections, calculated with a 3D regression plane, consider the orientation of each segmented granule, as described below.

In the following sections, a more detailed description of image processing and analyzing steps is presented.

The segmentation step aims at identify groups of pixels associated with an image of distinct granules. In the example involving wood chips, starting with a 3D image such as shown in FIG. 6, a second image is generated by taking the absolute value of maximal gradient calculated pixel by pixel, considering the eight (8) nearer neighbouring pixels. The values are limited to a predetermined maximal value, to obtain a gradient processed image such as presented in FIG. 13.

Then, a thresholding is performed to generate an inverted, binary image such as the image portion shown in FIG. 14.

Morphological operations of dilatation and erosion are followed to eliminate noise, to bind isolated pixels by forming clouds and to promote contour closing, providing an image such as shown in FIG. 15.

From the contours, a pre-selection of regions to retain for statistical data is performed by eliminating the regions whose contour is too long with respect to area (ratio perimeter/area) to belong to a single chip, such as performed on the image shown in FIG. 16.

Then, obstruction zones where a granule covers another are searched by applying a step filter according to lines and columns of the raw image such as shown in FIG. 6. Hence, a processed image such as shown in FIG. 17 is obtained, wherein the columns and lines where an obstruction has been detected are indicated by distinct levels of grey (e.g. columns: pale, lines: dark). Then, the program computes a selection function that is dependent upon the total number of pixels within the region and the obstruction ratio. That function enables the selection of groups of pixels associated with image zones corresponding to distinct granules, by retaining the large granules characterized by a slight obstruction (in percentage of area) while eliminating the granules having a major hidden portion. FIG. 18 is a final image resulting from segmentation step, superimposed on the raw image of FIG. 6 and showing the distinct particles in grey.

As mentioned above, the last step before statistical data compiling consists of computing the geometric correction to consider the surface orientation of the chips. Conveniently, a regression plane is calculated on the basis of points corresponding to each distinct chip in the raw image such as shown in FIG. 6. The correction for area measurement is the arithmetic inverse cosine of the angle between the normal of regression plane and Y axis as represented in FIG. 5.

As also mentioned above, the estimation of distributions from the inspection of granules in bulk may involve bias of a statistical nature. To the extent that the bias function is stationary, compensation thereof is possible to infer the actual distribution from the estimated one. An empirical relation linking a dimensional distribution estimated from the inspection of granules in bulk and the actual dimensional distribution of chips constituting the inspected matter can be obtained through a determination of a square matrix of N×N elements, wherein N is the number of groups used for the distribution. By considering that each group i of the actual distribution contributes according to an amplitude aⱼᵢ to the group j of the estimated distribution, the following relation is obtained:

$${T}_{j} = {\sum }_{i} {a}_{ji} {D}_{i} \qquad ( 1 )$$

wherein Tⱼ is a normalized value of estimated distribution for a group j and Dᵢ is the i^{th} normalized value of the actual distribution. For the whole distribution, the following matrix equation is obtained:

T=AD (2)

Wherein T and D are column-vectors containing the observed distributions and A is the matrix to be determined. Finally, one obtains:

D=A⁻¹T (3)

Hence, the inversion of matrix A enables to obtain the relation between the distribution estimated from inspection of the granules in bulk and the actual distribution.

The relations between chip properties and refining SEC have been identified and used in a simulation model programmed on a computer in order to predict pulp quality from chip properties and refiner operating conditions. The simulation results have been then used to define a strategy for stabilizing chip mixture density so as to reduce refining SEC by reducing the variability of chip properties, as will be explained later in more detail. The method used to obtain the relations between chip properties and SEC for a given pulp quality consisted of performing chip quality, pulping process and pulp quality evaluations. Chip quality evaluation basically consists of determining chip quality-related properties, which include wood species, basic and bulk densities for each species, chip freshness as indicated by brightness (luminance), moisture content (surface, global) and size distribution. Trials at a pilot plant were carried out in order to find the impacts of the wood chip properties on refining energy.

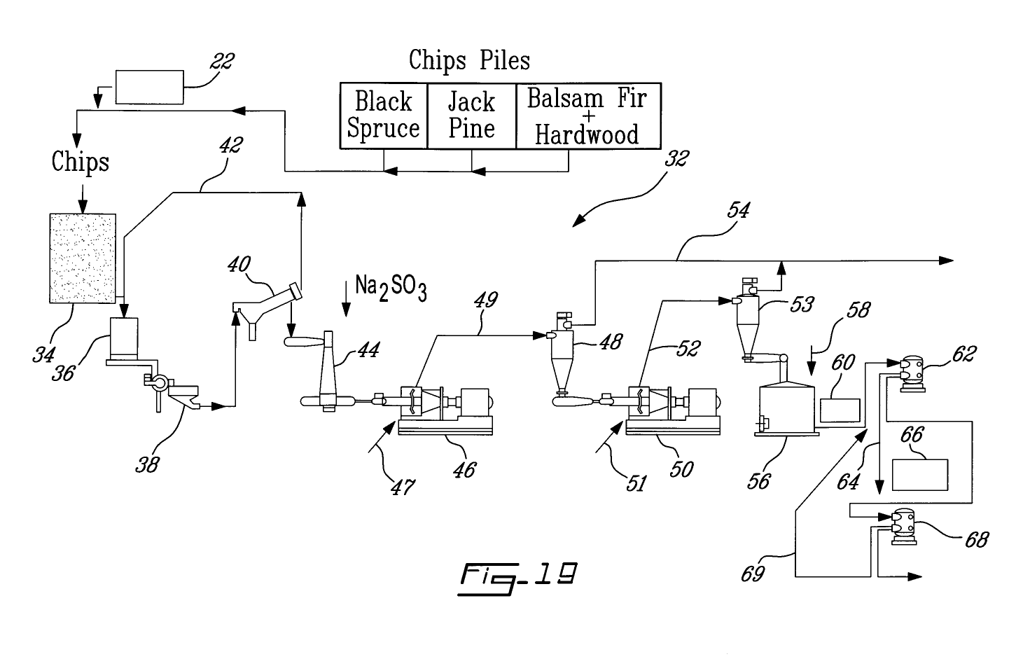

To be applicable to an existing pulping mill process, the operating conditions used in a typical mill has been recreated, namely a 2-stage CTMP (chemi-mechanical TMP) pulping process such as generally designated at 32 in FIG. 19, which includes a chip retention silo 34, followed by a chip pre-treatment stage making use of a chip bin 36, washer 38 and plug screw drainer 40 with optional recycling line 42. The process further includes a first refining stage for producing through line 49 partially refined pulp, which makes use of a steaming vessel 44 fed with sulfonation agent such as sodium sulphite (Na₂SO₃), a primary refiner 46 with dilution at 47 and a primary cyclone steam separator 48. The process also includes a second refining stage for producing wholly refined pulp through line 52, which makes use of a secondary refiner 50 with dilution at 51, and a secondary cyclone steam separator 53. Primary and secondary refiners may be chosen to operate either at atmospheric or pressurized conditions, and the saturated steam generated by cyclone steam separators 48 and 42 can be evacuated through line 54 for heat recovery. The process further makes use of a latency chest 56 with dilution at 58 for removing latency from refined pulp, and the resulting refined pulp leaving the latency chest 56 can be subjected to quality testing using an appropriate measurement system at 60 such as Pulp Qualiy Monitor (PQM) available from Metso Automation Canada Ltd (St-Laurent, Quebec, Canada). The process may also include a pulp screening stage including a primary screen 62 at a first outlet 64 of which the accepted pulp may leave and be subjected to further quality testing using an appropriate measurement system at 66 such as Pulp Expert™ also available from Metso Automation Canada Ltd. The screening stage may further include a secondary screen 68 receiving the pulp rejected by primary screen 62 and provided with optional recycling line 69.

The trials have explored different experimental values for chip properties (density, size, etc.) that could not be tried in the context of an actual, continuous mill production. According to some Canadian mills' experiences, variations in percentages of wood species have been proposed in the ranges seen in Table 1.

TABLE 1

| Wood species | % of total mixture |
|---|---|
| Black spruce | 70%-90% |
| Balsam fir | 0%-15% |
| Jack pine | 0%-20% |
| Hardwood | 0%-10% |

So to as reflect mill's actual species ranges, five (5) chip mixtures as described in Table 2 were subjected to pilot trials.

TABLE 2

| Wood | Mixture 1 | | | | |
|---|---|---|---|---|---|
| species | (typical) | Mixture 2 | Mixture 3 | Mixture 4 | Mixture 5 |
| Black spruce | 80% | 90% | 70% | 75% | 85% |
| Fir | 5% | 10% | 0% | 15% | 5% |
| Pine | 10% | 0% | 20% | 5% | 5% |
| Hardwood | 5% | 0% | 10% | 5% | 5% |

The typical mixture being the most representative of the one used at the considered mill, it reflects the normal operating conditions. Mixtures 2 and 3 were used to verify the influence of maximum and minimum spruce presence, respectively, on energy consumption. Mixtures 4 and 5 provide information on proportions still representative of the typical mixture, but with more or less amounts of fir.

The pilot trials demonstrated the effect of species and density, considering that basic density of each species as well as bulk density of each mixture were different. More particularly, the impact of wood species proportions on SEC to produce a predetermined pulp quality (CSF) was measured.

Previous results showed that moisture content also plays a role in pulp quality, a high proportion of moisture conferring better resistance properties to the resulting paper, as discussed by Eriksen et al. in “Consequences of Chip quality for Process and Pulp Quality in TMP Production”, International Conference, Mechanical Pulping, Oslo, June (1981). However, while chip freshness is another important parameter in the TMP process as playing a prominent role in determining bleaching agent consumption, its effect on the refining energy had not been heretofore considered. According to the proposed approach, the impact of chip freshness and moisture content on pulp quality and SEC were determined experimentally. For so doing, chips were dried at two different levels from their natural state. The moisture content variation was in the range of 36%-48% by controlling drying rate. A mixture typical of the normal mill operation was used as described in Table 3, in terms of wood species content and aging measurement data represented by brightness loss.

TABLE 3

| | |
|---|---|
| Typical | Brightness loss |

| Wood species | mixture | Trial 1 | Trial 2 |
|---|---|---|---|
| Black spruce | 80% | 3 levels | 6 levels |
| Fir | 5% | | |
| Pine | 10% | | |
| Hardwood | 5% | | |

As to size distribution, it was demonstrated that the needed SEC to obtain a pulp of CSF 500 mL decreases proportionally with chip size, as reported by Marton et al. in “Energy Consumption in Thermomechanical Pulping”, TAPPI, 64-8, p. 71 (1981). However, chip size has no effect on SEC for pulps refined to CSF values of less than 500 mL. Therefore, smaller chips help decrease SEC but those of lengths lower than 5 mm will produce pulps that have weaker resistance properties. For a fixed SEC, a superior pulp quality (fibre length, adhesion) will be obtained with thickness between 4 and 8 mm, as taught by Hoekstra et al. in “The Effects of Chip Size on Mechanical Pulp Properties and Energy Consumption”, International Conference, Mechanical Pulping, Washington, June, 1983, or with lengths between about 16 and 22 mm. The need for SEC increases for a fixed CSF when thickness is higher than 6 mm or when length is about 19 mm. The categories of smallest chips as well as largest ones were refined twice for experimental error verification purposes. The average size distribution of three (3) batches of the typical mixture as used in pilot trials is given in Table 4. For the purposes of trials, the relative content of wood chips of each size category was chosen to form a medium, acceptable size batch and two unacceptable size batches, respectively containing excessive contents of small and large size wood chips, respectively.

TABLE 4

| Width (mm) | Small (%) | Medium (%) | Large (%) |
|---|---|---|---|
| <=5 | 1 | 1 | 1 |
| 5-9 | 24 | 12 | 4 |
| 10-15 | 40 | 30 | 25 |
| 16-28 | 32 | 45 | 65 |
| >29 | 2 | 12 | 5 |

The correlations between the specific chip properties and pulp quality were determined and tested through pilot trials and served to determine optimal operation strategies, on the basis of specific or trend data indicating the most suitable chip properties such as density and size distribution for producing pulp of an acceptable quality while minimizing specific energy consumption. For the purposes of mill validation of optimal control strategies, the CMS and CWS systems along with volume sensor and chip sizing subsystem were installed in the mill, to provide online measurement information allowing to obtain the relations between needs in refining SEC and chip properties, i.e. for a given pulp quality, to establish the impact of chip quality on refining energy. The measurement systems allowed the observation of interactions between mean values obtained at the trials (CSF, SEC, chip properties), and of the variability effect of each of these values (standard-deviation) on the other ones of these values. The determination of relations between chip quality and pulp quality was successful for different proportions of wood species and different chip conditions, so that the found relations were considered reliable.

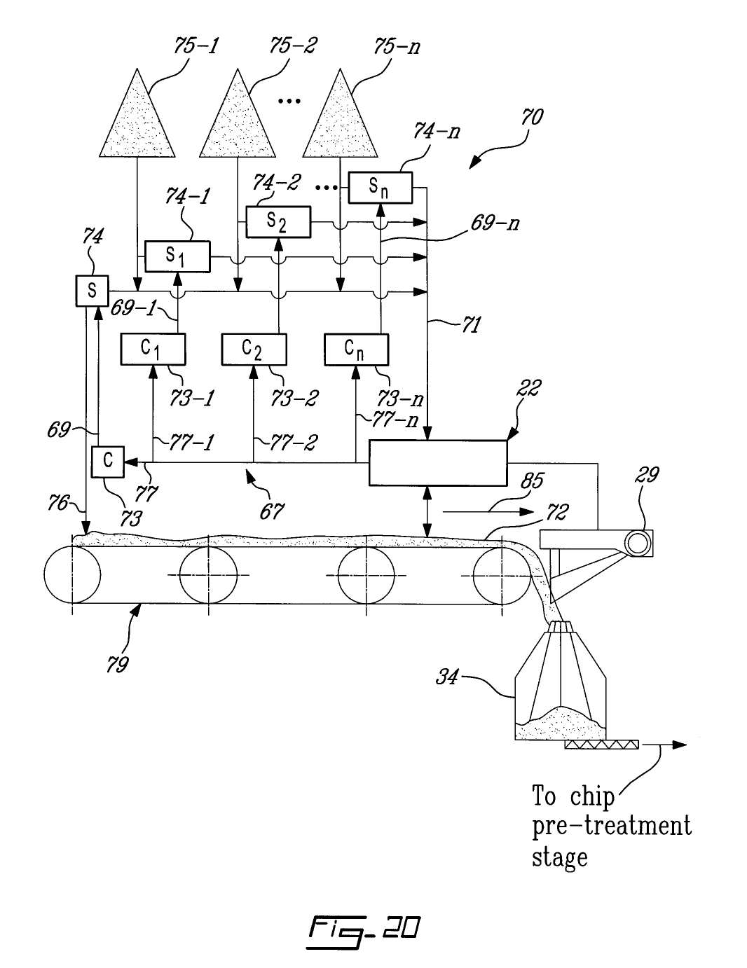

In order to first stabilize chip quality, the dry bulk density of the mixtures (dry weight/wet chip volume) is controlled at the chip feeding stage by a chip pile dosage stage generally shown at 70, which includes a matter flow control unit generally designated at 67 that will now be described in view of FIG. 20. Alternatively, another wood chip property such as basic density may be used, depending upon the operator's choice. A way to accomplish this control is described in U.S. Patent application published under No. 2006/0278353 as cited above. At the process entrance point of the chips 72 on the conveyer 79, the chip quality online measurement system 22 referred to above is provided, for performing measurements of the passing chip mixture's properties (i.e. brightness, darkness, weight and mass flow rate, volume and volume flow rate, densities, moisture content, bark content). Screw speed controllers 73-1 to 73-n are assigned to the species chip feeding screws 74-1 to 74-n through respective control lines 69-1 to 69n, receiving chips from n corresponding piles 75-1 to 75-n in the example shown. A desired set point value for a controlled wood chip property selected by the operator, such as dry bulk density or basic density, is given to the computer unit of measurement system 22, which receives through data line 71 speed measurement values from sensors (not shown) provided on each of screws 74-1 to 74-n. In operation, the species proportions are handled by screw speed controllers 73-1 to 73-n, using respective set point values through lines 77-1 to 77-n to control the speed of each one of the screws, so that a resulting mix of chip from pile 75-1 to pile 75-n is discharged on conveyor 79 as indicated by arrow 76 though main discharging screw 74 provided with speed sensor (not shown) and linked through control line 69 to a controller 73 receiving its set point value from the computer unit 23 of measurement system 22 through line 77 on the basis of speed measurement value obtained through data line 71. Whenever the chip mixture property values become unacceptable or exhibit a tendency towards unacceptable values, a selective adjustment of screw speed is performed by the controllers 73, 73-1 to 73-n accordingly to stabilize the controlled chip property, thereby providing more or less of the necessary species to the resulting mixture. For example, if too much black spruce is used according to the set point value of this species' needed value, the associated controller (for example 73-1) will react by decreasing corresponding screw speed to bring spruce presence to a normal percentage. For so doing, the feed screw speed set points are adjusted to reverse the unacceptable tendency (ex. too high density) by mixing new mixture proportions. The stabilized flow of chips can then be subjected to size measurement by passing in the direction of arrow 85 through the sensing field of chip sizing subsystem 29 as part of measurement system 22 prior to be discharged to retention silo 34.

Once the chip quality values were stabilized to a predetermined level according to the relations found at the pilot trials, a prediction of the obtained pulp quality was carried out at the mill. The results of pilot trials and mill trials were then compared, and no significant deviation between the results was observed.

The measurement system 22 described above can be used as a decision support system (DSS) capable of helping operators to minimize the SEC through a predictive control over the refining process. From the measurement results, and simultaneously with the applied feedback control described above, operators can notice chip property predictions and tendencies before the chips reach the retention and preheating retention silos disposed upstream the refining stage. In this way, operators have time to take necessary precautions and make appropriate adjustments on the process parameters (plate gap, dilution flow rate, chip transfer screw speed) to counter any unacceptable tendency exhibited by the chip properties signalled by the measurement systems. In the context of the previously discussed example concerning bulk density, if the measured value for that property is found to be too high, that value is displayed at the operator's refining line monitoring station when the chips have just passed through the measurement systems. Having real-time information on chips density as well on the trend taken by the chips, and knowing that at a future, predetermined time period (for example in 15 minutes), the analysed chips when being refined will have the measured density, the operator is capable of manipulating the process parameters to produce an acceptable quality pulp considering the measured density value.

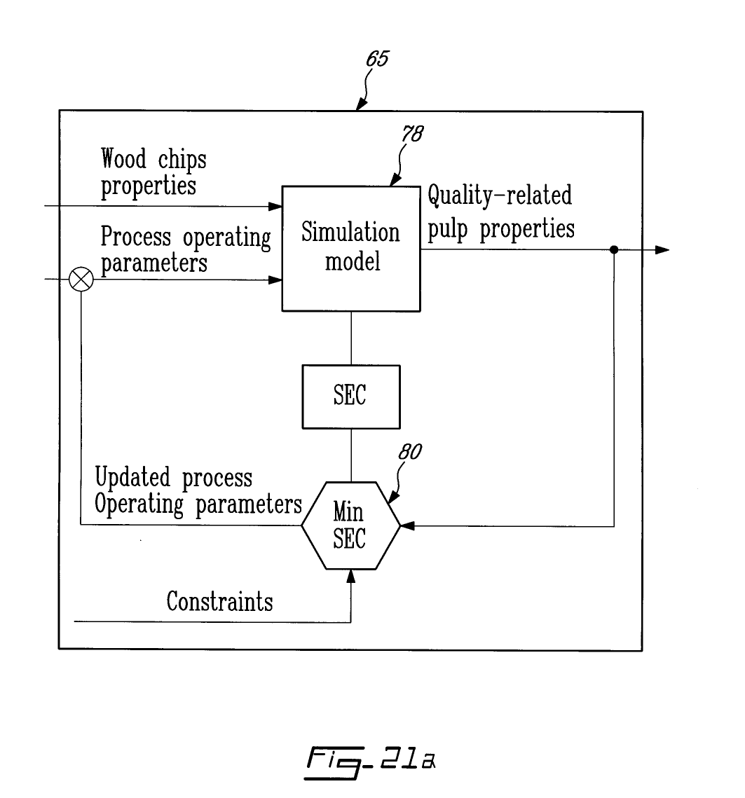

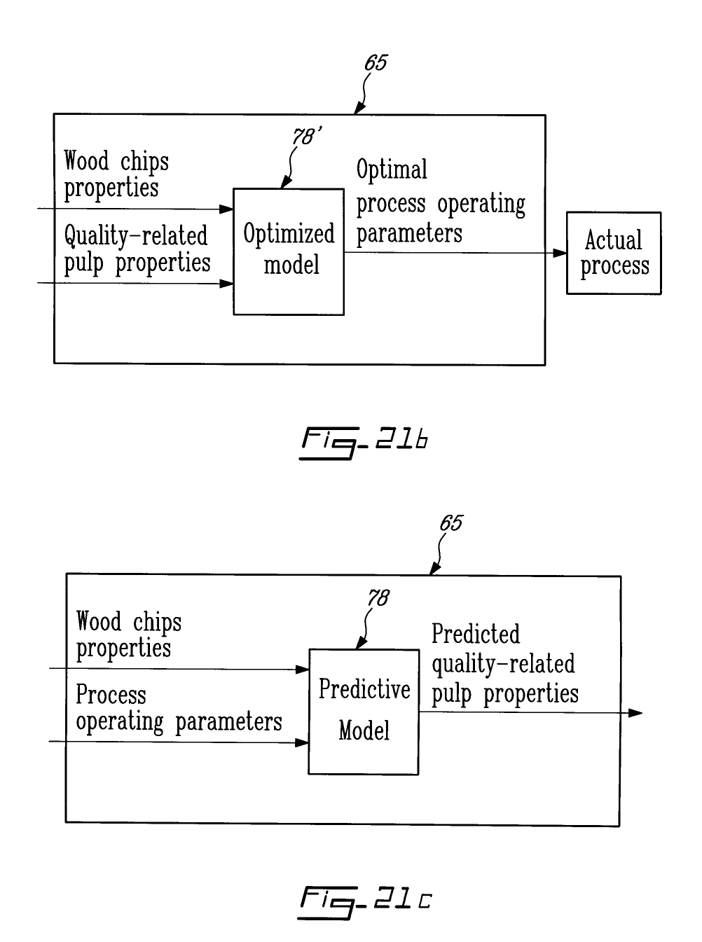

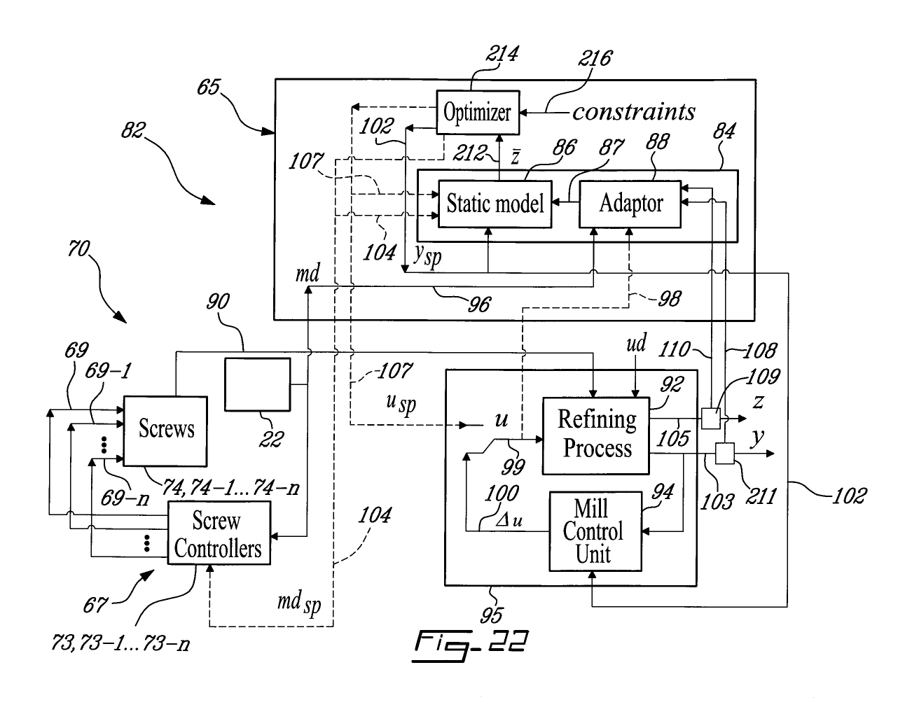

The mill was then modeled for pulp quality prediction and refining process optimization purposes, on the basis of the properties of chips entering the primary refiner, considering some refining process input operating parameters such as matter transfer screw speed, dilution flow rate, hydraulic pressure or plate gaps, and retention time delays. For so doing, the simulation software CADSIM Plus™ from Aurel Systems Inc. (Burnaby, BC, Canada) was used. Any other appropriate simulation tool such as the Simulink™ from Mathworks (Natick Mass.) could have alternatively been used. Referring now to FIG. 21a, a basic SEC optimization structure for use with a simulation model 78 of a lignocellulosic granular matter refining process programmed on the data processor of computer 65 is shown. The simulation model 78 is based on the above-mentioned relations involving a plurality of matter properties (i.e. moisture content, density-related properties, light reflection-related properties, granular matter size) characterizing the granular matter to be fed to the process, the refining process input operating parameters and at least one refining process output parameter (e.g. CSF, primary motor load, SEC, energy split, long fiber, fines and shives contents). Conveniently, the simulation model is a static model built with an appropriate modelling platform (e.g. neural network, multivariate linear model, static gain matrix, fuzzy logic model). The simulation model 78 is optimized according to a condition of minimum refining specific energy consumption (SEC) and to one or more predetermined process constraints related to one or more of the matter properties, refining process input operating parameters and refining process output parameters, to obtain an optimized refining process model. Fore example, the optimization structure may involve the application of constraints on the quality-related pulp properties such as CSF (ex: CSFₘᵢₙ<CSF<CSFₘₐₓ), long fiber, fines and shives contents. According to the initial chip properties and refining process input operating parameters, the simulation model 78 finds, through iterations at 80, updated parameter values providing the lowest specific energy while satisfying the specified constraints.

In practice, as shown in FIG. 21b, provided with optimal input operating parameters for the refining process, the computer 65 implementing a part or the whole of optimized simulation model 78′ can be used in a system for operating an actual refining process in an open-loop control configuration. This involves a consideration of the impact of chip properties and optimal process operating parameters with respect to refining energy and subject to desired pulp quality constraints. The optimized refining process model 78′ is fed with data representing measured values of matter properties and data representing a target for the refining process output parameter (such as quality-related pulp properties) to estimate an optimal value of at least one of the input process operating parameters. The estimated optimal operating parameters are manipulated by means of the controllers used by the actual process.

Referring now to FIG. 21c, it can be seen that the computer 65 implementing a part or the whole of the simulation model 78 can also be used in a system for predicting a value of at least one refining process output parameter (such as quality-related pulp properties) using data representing matter properties and actual input operating parameters as measured.

As mentioned above in view of the graph of FIG. 2, the optimization of the refining process involves a displacement of the operating conditions from a current or nominal operation point to a selected, more optimal operating point. However, this displacement must take into account the manoeuvring margin provided by the refiner control system in order to ensure operating stability in presence of external disturbances. In the particular case of the TMP process, optimization of the refining energy consumption depends on chip properties (external disturbances), on the control system used, as well as on constraints inherent to process design (e.g. transfer screw speed, maximum hydraulic pressures on refiner plates, etc.). By definition, a degree of freedom is a process parameter apt to be freely manipulated. Hence, in a general optimization context, the available degrees of freedom are adjusted so as to either maximize or minimize a parameter of an economic nature. The TMP refining process typically involves a limited number of available degrees of freedom to perform energetic optimization since most of manipulable parameters are already used by the mill control system. The available, optimized degrees of freedom allow to traverse the control system limitations when facing with non-linearity of the refining process and seasonal disturbances affecting it.

Referring now to FIG. 22, there is shown a schematic block diagram representing a chip refining optimization and control system generally designated at 82 capable of minimizing SEC according to predetermined constraints imposed on controlled output parameters y (e.g. CSF, primary motor load), on uncontrolled output parameters z (e.g. SEC, energy split, long fiber, fines and shives contents) or on manipulated input parameters (e.g. transfer screw speed, hydraulic pressures, dilution flow rates, plate gaps, and retention time delays). The chip refining optimization and control system 82 shown in FIG. 22 basically comprises the computer 65 programmed with a predictive model 84 designed according to the specific parameters characterizing the process to be controlled, such as hydraulic pressures in refiners, refiner motor loads, production rate, total specific energy, consistency within refiners, refiner dilution flow rates, refining plate wear, etc. The predictive model 84 includes a static model 86 that can be built with a neural network, a multivariate linear model such as PLS (Projection to Latent Structures), a static gain matrix, a fuzzy logic model, or on any other appropriate modeling platform. The predictive model includes an adaptor 88 for taking into account the non-stationary nature of the refining process, by periodically updating the properties of the static model 86 as indicated by arrow 87. The predictive model 84 is validated through simulations of the chip transfer line 90, refining process 92 and mill control unit 94 in steady and dynamic modes of operation, as integrated in a simulation module 95 programmed in the computer 65.

According to the proposed approach, the degrees of freedom used to optimize refining energy are classified in three categories depending upon their respective roles in the refining operation. The first, basic category, namely the optimal control set points Yₛₚ, includes refining targets and targets for pulp quality-related properties, which are at high level in the control hierarchy. In a typical TMP refining process, the target for CFS as obtained with a pulp testing system such as Pulp Quality Monitor (PQM) or Pulp Expert™ from Metso Automation Canada Ltd (St-Laurent, Quebec, Canada) and the target for primary refiner motor load can be used as optimal control set points yₛₚ. The second category, namely optimal quality-related properties of wood chips mdₛₚ which are associated with measured disturbances md, may includes the target for basic density or the dry bulk density as measured by the measurement system 22 provided on the chip pile dosage stage, as well as any target for other useful measured parameters related to chip quality (e.g. brightness, LU moisture content, brightness, darkness, size distribution). The use of the latter category is optional and requires the integration of chip feeding screws 74, 74-1 to 74-n and associated screw controllers 73, 73-1 to 73-n for all chip piles into the optimization calculations. Otherwise, only the quality-related properties of wood chips md are fed to the predictive model from measurement system 22 through data line 96, and an independent screw control may be performed as described above in view of FIG. 20. The third category, namely optimal manipulated parameters uₛₚ, is also optional and includes the nominal values of manipulated parameters, which are at low level in the control hierarchy. In a typical TMP refining process, nominal values of either primary refiner transfer screw speed, hydraulic pressures, dilution flow rates or sulfonation flow rate can be used. Conveniently, the cascade-implemented control devices of the mill control unit 94 which regulate these process parameters can be modified for providing manipulated input parameter values u to the predictive model adaptor through optional data line 98 to ensure a regulation using control adjustment values Δu (with u=uₛₚ+Δu through data line 99) as indicated by feedback data line 100 around the optimal nominal values. Otherwise, the optimization calculations are performed without the degrees of freedom of the third category.

More specifically, the inputs of the static model basically includes Yₛₚ through data line 102 as will be explained below in more detail, and optionally mdₛₚ or uₛₚ through optional data lines 104 or 107, respectively, and the adaptor receives the measured chip properties md, the optional u values through data line 98 as well as the resulting controlled and uncontrolled output parameters y and z measured by meters 109 and 211 at outputs 103 and 105 through feedback data lines 108 and 210, respectively. Appropriate types of meters 109 and 211 are chosen depending on the nature of controlled (e.g. CSF, primary motor load), or uncontrolled (e.g. SEC, energy split, long fiber, fines and shives contents) parameters involved. For example, wattmeters can be used to measure primary motor load and energy split, while PQM or Pulp Expert™ can be used to measure CSF as well as long fiber, fines and shives contents. The output of the predictive model consists of predicted output parameters z̅ as indicated by arrow 212, which are usually not controlled with respect to targets (e.g. SEC, energy split, long fiber, fines and shives contents). The computer 65 is further programmed with an optimizer 214 designed to minimize SEC on the basis of predetermined constraints imposed on y, z or u fed at input 216, and of predicted output parameters z̅ received from the predictive model as indicated by arrow 212, to update the values of Yₛₚ and optionally of uₛₚ and mdₛₚ. Updated values of Yₛₚ are sent to static model 86 and mill control unit 94 through data line 102, while updated values of uₛₚ and mdₛₚ are respectively directed to the refining process 92 through optional data line 107 and to the screw controllers 73, 73-1 to 73-n through line 104, as well as to static model 86. Once a successful process simulation is obtained, the simulation module 95 can be substituted by the actual refining process and mill control system for actual refining operation.

Conveniently, the optimizer performs its parameter updating function in accordance with a predetermined period of time Δtₒₚₜ whose value may be chosen considering the mean latency time of the refining process and the reacting time of the pulp quality control loops used by the mill control unit 94. The operation of the optimizer starts at an initial time t with the acquisition of the measured disturbances md, which are used to calculate the estimated values of Yₛₚ and optionally mdₛₚ or uₛₚ that minimize for a next period of time Δtₒₚₜ a predetermined function f so that min f=SEC. Since the static model 86 at the basis of the predictive model 84 can be developed from actual mill operation data covering a broad range of practicable operating conditions, the mill control unit 94 is normally capable of stabilizing the refiner operation according to the preset targets within the current period of time Δtₒₚₜ, and the calculations is repeated at a next time t=t+Δtₒₚₜ.

t is to be understood that even if the approach according to the invention has been applied in the context of a TMP or CTMP process as described above, other applications where a refiner or similar device is used for defibering lignocellulosic granular matter are contemplated, such as used in mechanical pulping and semi-mechanical pulping processes.

Applications of the present invention to a refining stage of MDF or HDF fiberboard production process are also contemplated. In such processes, refiners are used to break down the wood matter that may includes wood chips, mill waste matters such as wood shavings, sawdust or processed wood flakes (e.g. OSB flakes). into fibres (fiberize or defibrate) of predetermined size depending on the target density of the fiberboard. For example, Medium-Density Fiberboard (MDF) and Hard-Density Fiberboard (HDF) typically have density values of 500-1450 Kg/m³, respectively. In a typical MDF process, the pulp (also called fibre mat) that exists from the refiner is mixed with wax to provide moisture resistance and with a resin to stop agglomeration. After drying, the mixture is pressed and cut into boards. While their respective post-refining steps are distinct, the refining modes of operation of fiberboard manufacturing and pulp and paper processes are similar, and the systems and methods as described above may also be used to provide a more cost effective and efficient fiberboard manufacturing process.

We claim:

1. A method for optimizing the operation of a lignocellulosic granular matter refining process using a control unit (94) and at least one refiner stage (92), said process being characterized by a plurality of input operating parameters, at least one output parameter being controlled by said unit (94) with reference to a corresponding control target, and at least one uncontrolled output parameter, said method comprising the steps of:
i) providing a predictive model (84) including a simulation model (86) for said refining process and an adaptor (88) for said simulation model, said simulation model being based on relations involving a plurality of matter properties characterizing lignocellulosic matter to be fed to said process, said refining process input operating parameters, said controlled output parameter and said uncontrolled output parameter, to generate a predicted value of said uncontrolled output parameter;
ii) feeding the simulation model adaptor (88) with data representing measured values of said matter properties and data representing measured values of said controlled and uncontrolled output parameters, to adapt the relations of said simulation model accordingly; and
iii) providing an optimizer (214) for generating an optimal value of said control target according to a predetermined condition on said predicted value of said uncontrolled output parameter and to one or more predetermined process constraints related to one or more of said matter properties, said refining process input operating parameters and said refining process output parameter.

2. The method according to claim 1, wherein said lignocellulosic granular matter is selected from the group consisting of wood chips, wood shavings, sawdust and processed wood flakes.

3. The method according to claim 1, wherein said uncontrolled output parameter is selected from the group consisting of specific energy consumption, energy split, long fiber, fines and shives contents.

4. The method according to claim 1, wherein said uncontrolled output parameter is specific energy consumption, said predetermined condition relates to a minimization of said refining specific energy consumption.

5. The method according to claim 4, wherein at least one of said input operating parameters is manipulated by said refining process control unit with reference to a corresponding operation target and said step ii) further includes feeding the simulation model adaptor (88) with data representing measured values of said manipulated input operating parameter, said optimizer (214) further generating an optimal value of said operation target according to said predetermined condition and said one or more predetermined process constraints.

6. The method according to claim 4, wherein the matter refining process is fed by a matter pile dosage stage (70) provided with a matter flow control unit (67) used to manipulate matter dosage parameters with reference to a corresponding target for one of said matter properties, said relations on which the simulation model is based further involving said matter dosage parameters, said optimizer (214) further generating an optimal value of said matter property target according to said predetermined condition and said one or more predetermined process constraints.

7. The method according to claim 4, wherein said matter properties include moisture content.

8. The method according to claim 7, wherein said matter properties further include at least one density-related property.

9. The method according to claim 8, wherein said matter properties further include at least one light reflection-related property expressed as at least one optical parameter.

10. The method according to claim 9, wherein said optical parameter is luminance.

11. The method according to claim 9, wherein said optical parameter is selected from the group consisting of hue, saturation, and darkness indicator.

12. The method according to claim 9 wherein said at least one light reflection-related matter property is expressed as a plurality of optical parameters including hue, saturation and luminance.

13. The method according to claim 12, wherein said plurality of optical parameters further includes darkness indicator.

14. The method according to claim 8, wherein said matter properties further include granular matter size.

15. The method according to claim 1, wherein said simulation model (86) is a static model built with a modelling platform selected from the group consisting of a neural network, a multivariate linear model, a static gain matrix and a fuzzy logic model.

16. The method according to claim 1, wherein said controlled output parameter is selected from the group consisting of primary motor load and pulp freeness.

17. The method according to claim 1, wherein said refining process input operating parameters are selected from the group consisting of matter transfer screw speed, dilution flow rate, hydraulic pressure, plate gaps, and retention time delays.

18. A system (82) for optimizing the operation of a lignocellulosic refining process using a control unit (94) and at least one refiner stage (92), said process being characterized by a plurality of input operating parameters, at least one output parameter being controlled by said unit (94) with reference to a corresponding control target, and at least one uncontrolled output parameter, said system comprising:
means (22) for measuring a plurality of matter properties characterizing lignocellulosic matter to be fed to said process, to generate matter property data;
means (109,211) for measuring said controlled and uncontrolled output parameters, to generate output parameter data; and
data processor means (65) implementing a predictive model including a simulation model for said matter refining process which is based on relations involving said plurality of matter properties, said refining process input operating parameters, said controlled output parameter and said uncontrolled output parameter, to generate a predicted value of said uncontrolled output parameter, said data processor means (65) further implementing an adaptor (88) for said simulation model (86) receiving said matter property data and said output parameter data to adapt the relations of said simulation model accordingly, said data processor means (65) further implementing an optimizer (214) for generating an optimal value of said control target according to a predetermined condition on said predicted value of said uncontrolled output parameter and to one or more predetermined process constraints related to one or more of said matter properties, said refining process input operating parameters and said refining process output parameter.

19. The system according to claim 18, wherein said lignocellulosic granular matter is selected from the group consisting of wood chips, wood shavings, sawdust and processed wood flakes.

20. The system according to claim 18, wherein said uncontrolled output parameter is selected from the group consisting of specific energy consumption, energy split, pulp freeness, long fiber, fines and shives contents.

21. The system according to claim 18, wherein said uncontrolled output parameter is specific energy consumption, said predetermined condition relates to a minimization of said refining specific energy consumption.

22. The system according to claim 21, wherein at least one of said input operating parameters is manipulated by said refining process control unit (94) with reference to a corresponding operation target and said step ii) further includes feeding the simulation model adaptor (88) with data representing measured values of said manipulated input operating parameter, said optimizer further generating an optimal value of said operation target according to said predetermined condition and said one or more predetermined process constraints.

23. The system according to claim 21, wherein the matter refining process is fed by a matter pile dosage stage (70) provided with a matter flow control unit (67) used to manipulate matter dosage parameters with reference to a corresponding target for one of said matter properties, said relations on which the simulation model is based further involving said matter dosage parameters, said optimizer (214) further generating an optimal value of said matter property target according to said predetermined condition and said one or more predetermined process constraints.

24. The system according to claim 21, wherein said matter properties include moisture content.

25. The system according to claim 24, wherein said matter properties further include at least one density-related property.

26. The system according to claim 25, wherein said matter properties further include at least one light reflection-related property expressed as at least one optical parameter.

27. The system according to claim 26, wherein said optical parameter is luminance.

28. The system according to claim 26, wherein said optical parameter is selected from the group consisting of hue, saturation, and darkness indicator.

29. The system according to claim 26 wherein said at least one light reflection-related matter property is expressed as a plurality of optical parameters including hue, saturation and luminance.

30. The system according to claim 29, wherein said plurality of optical parameters further includes darkness indicator.

31. The system according to claim 25, wherein said matter properties further include granular matter size.

32. The system according to claim 18, wherein said simulation model is a static model built with a modelling platform selected from the group consisting of a neural network, a multivariate linear model, a static gain matrix and a fuzzy logic model

33. The system according to claim 18, wherein said controlled output parameter is selected from the group consisting of primary motor load and pulp freeness.

34. The method according to claim 18, wherein said refining process input operating parameters are selected from the group consisting of matter transfer screw speed, dilution flow rate, hydraulic pressure, plate gaps, and retention time delays.
